(19) United States
(12) Patent Application Publication
(10) Pub. No.: US 2019/0240787 A1
(43) Pub. Date: Aug. 8, 2019

(54) THREE-STAGE PROCESS FOR PRODUCING COOLING AIR BORES BY MEANS OF A NANOSECOND AND MILLISECOND LASER AND COMPONENT

(71) Applicant: Siemens Aktiengesellschaft, München (DE)

(72) Inventors: Thomas Beck, Panketal (DE); Oliver Katzurke, Berlin (DE); Jens Dietrich, Falkensee (DE)

(21) Appl. No.: 16/339,239

(22) PCT Filed: Sep. 22, 2017
(86) PCT No.: PCT/EP2017/074064

§ 371 Date: Apr. 3, 2019

(30) Foreign Application Priority Data
Oct. 17, 2016 (DE) 10 2016 220 251.0

(51) Int. Cl. B23K 26/384; B23K 26/382

(52) U.S. Cl. CPC B23K 26/384; B23K 26/0624; B23K 26/389

(57) ABSTRACT

Through_holes having a high contour accuracy are produced by the multiple use of a nanosecond laser without that the interface between the ceramic layer and the substrate is damaged.

### CROSS-REFERENCE TO RELATED APPLICATIONS

This application claims priority to PCT Application No. PCT/EP2017/074064, having a filing date of Sep. 22, 2017, which is based off of German Application No. 10 2016 220 251.0, having a filing date of Oct. 17, 2016, the entire contents both of which are hereby incorporated by reference.

### FIELD OF TECHNOLOGY

An aspect relates to the production of a through-hole through a ceramic layer system and component.

### BACKGROUND

One established process chain for the boring of cooling air bores in hot-gas components such as turbine blades is laser boring with pulsed laser systems in the millisecond (ms) time range. These pulse durations are required in order to have sufficient energy in the pulse to be able to also bore deeply. In this case, boring is carried out through the entire coating system (ceramic/metal) of the blade. Subsequently, shaped bores (diffusers) are applied onto selected cylindrical bores with a short-pulse laser in the nanosecond (ns) time range. In this case as well, the shape geometry is introduced by laser ablation in the coated state through all the coats.

The process sequence of ms and then ns processing is necessarily prescribed since in the opposite case burn-off products and melting residues would contaminate the shape previously produced. In this way, its outflow behavior would no longer be ensured.

In detailed studies, it has now been shown that, during boring with the ms laser, long cracks may occur at the interface of the ceramic coating (TBC) with the MCrAlY layer. These cracks could be an initiator for premature failure of the TBC during operation.

EP 2 853 338 A1, EP 1 869 290 B1 and EP 1 973 688 B1 disclose methods for producing a through-hole through a ceramic layer system, with which a millisecond laser is used in order to remove ceramic.

### SUMMARY

An aspect relates to solve the problem mentioned above.

Advantageous process chain:
1. complete coating of the component in order to produce a ceramic layer system
2. ablation of a part of a ceramic layer (TBC) in the region of the future hole with an ns laser
3. boring through the position previously prepared (in 2.) with an ms laser,
4. introduction of the shape (diffusor) with an ns laser.

All three described boring processes (2.-4.) are carried out in a clamp. The position of the hole is uniquely defined by the 2^{nd} process step and is used further in process steps 3. and 4.

The TBC is thus removed with a tolerance of 0.1 mm-0.3 mm circumferentially in the region of the future hole. The ns pulses used are so short that no damage to the interface between the TBC and the substrate or underlying layers occurs.

The quality of the holes is better.

### BRIEF DESCRIPTION

Some of the embodiments will be described in detail, with reference to the following figures, wherein like designations denote like members, wherein:

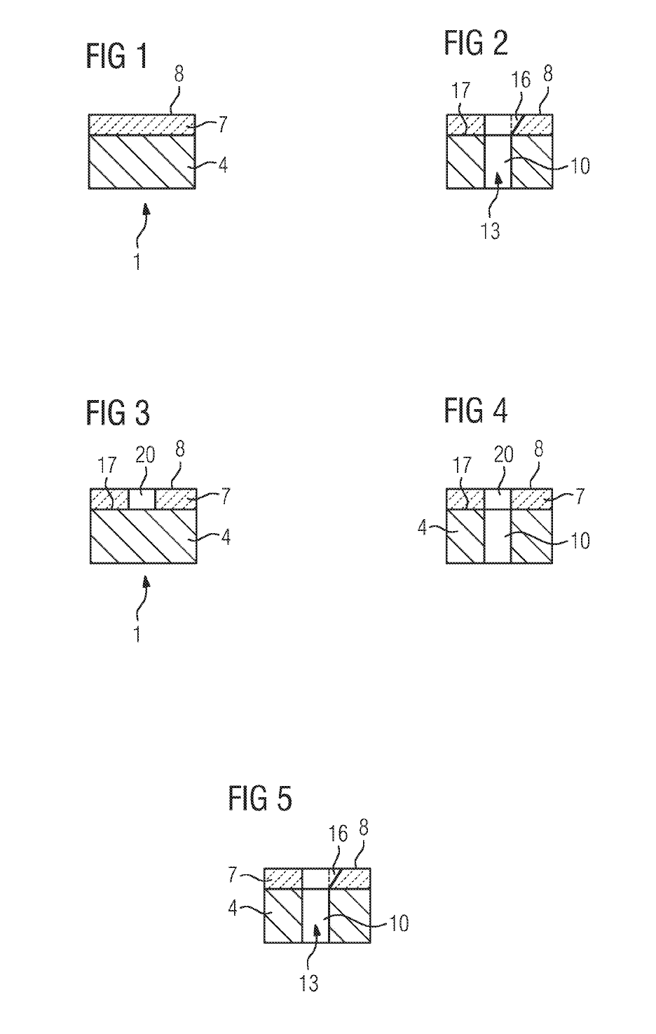

FIG. 1 shows a ceramic layer system;

FIG. 2 shows a geometry of a through-hole to be produced;

FIG. 3 shows a production step and the method;

FIG. 4 shows a production step and the method step;

FIG. 5 shows a production step and the method step;

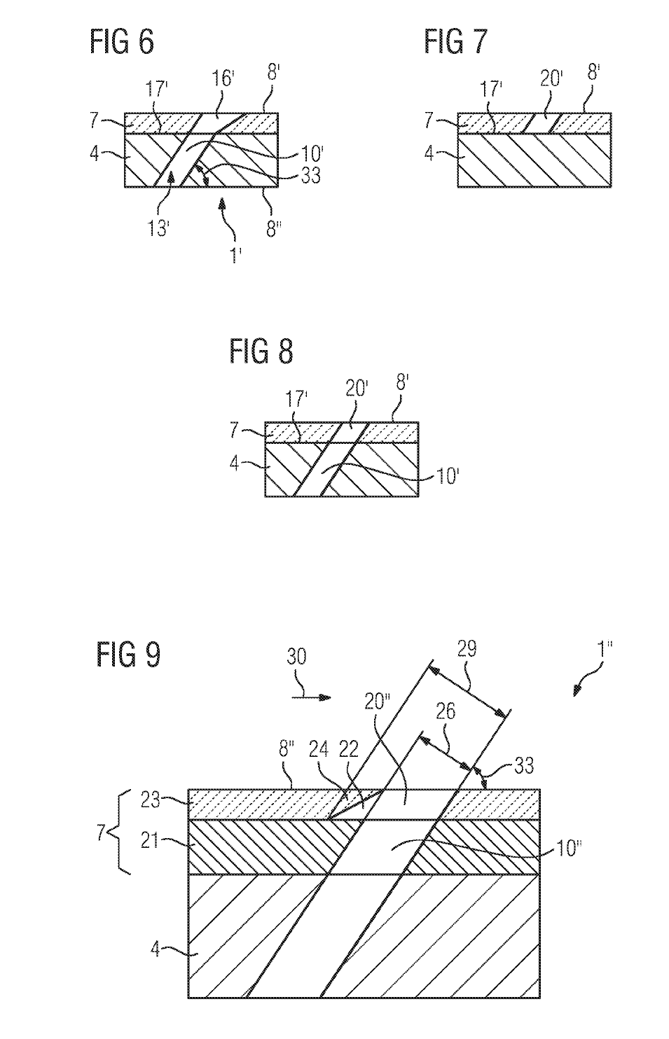

FIG. 6 shows a geometry of a through-hole to be produced;

FIG. 7 shows a production step and the method;

FIG. 8 shows a production step and the method;

FIG. 9 shows a production step and the method; and

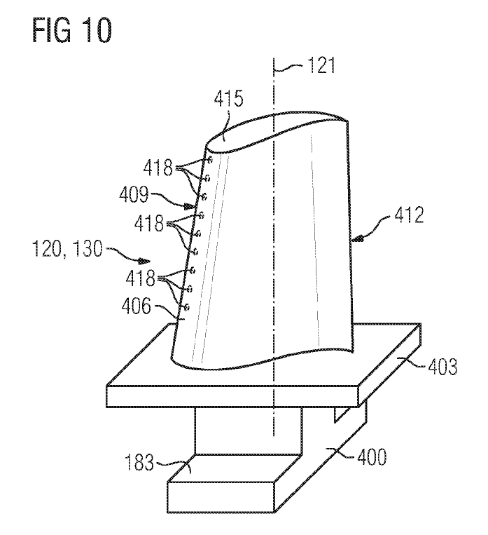

FIG. 10 shows a turbine blade.

The description and the figures only represent exemplary embodiments of the invention.

### DETAILED DESCRIPTION

FIG. 1 shows a ceramic layer system or component 1, 1′, 1″ (FIGS. 6, 9). The ceramic layer system 1, 1′, 1″ comprises at least one metallic substrate 4, in particular made of a nickel-based superalloy, on which one or more layers are arranged, in particular an outer ceramic layer 7, which in particular represents the outermost ceramic layer 7. The lower layers may be a metallic bonding layer, in particular based on NiCoCrAlY and/or a monolayer ceramic layer of a two-layer ceramic thermal barrier coating (TBC).

The outer or outermost ceramic thermal barrier coating 7, 23 (FIG. 9) may consist of zirconium oxide and/or pyrochlore.

The ceramic layers 7, 23 represent the outermost layers of this ceramic layer system 1, 1′, 1″.

FIG. 2 shows in cross section a through-hole 13 which is intended to be produced by means of the method according to embodiments of the invention.

The through-hole 13, 13′ (FIG. 6) comprises on the inside an in particular symmetrical or cylindrical inner part 10, 10′ (FIG. 6) (metering hole), the majority of which is located in the substrate 4.

At least in the ceramic layer 7, 23, there is a diffuser (16, 16′ (the dashed line indicates only the part of the enlargement of the inner part 10 of the diffuser), which differs significantly from the geometry or cross section of the metering hole 10 in that it represents a widening.

The inner part 10, 10′, 10″ may also extend at an angle 33 to the surface 17 (FIGS. 6, 9). The symmetry always relates to the longitudinal direction of the inner part 10, 10′, 10″.

According to embodiments of the invention, a part 20, 20′ of the diffuser 16, 16′ in the ceramic layer 7, 23 is first removed as far as the substrate 4 by means of a nanosecond laser by means of pulses (FIG. 3).

This part 20, 20′ does not correspond in its shape to the final geometry of the diffuser 16, but in cross section to that of the inner part 10, 10′ according to FIGS. 2, 6.

The lower part, i.e. the metering hole 10, 10′, 10″ according to FIG. 2, is then produced by means of a millisecond laser (FIG. 4).

In a last step (FIG. 5), the final geometry of the diffuser 16 is produced in the ceramic layer 7 again by means of a nanosecond laser by means of pulses in the nanosecond range, in particular up to 200 ns.

In contrast to the prior art, a nanosecond laser is deliberately used here in order to make the diffuser 16, 16′ in its shape close to final contour 20 (FIG. 3), 20′, 20″ (FIGS. 7, 9). A millisecond laser was always used for this in the prior art.

The following parameters for the nanosecond laser are advantageous:

the pulse duration is 50 ns-100 ns,
and/or
the power is 50 kW-150 kW,
and/or
the energy is 8 mJ-20 mJ,
and/or
the frequency is between 10 kHz-40 kHz.

The following parameters are particularly advantageous for the nanosecond laser:

the pulse duration is 100 ns,
and/or
the power is 100 kW
and/or
the energy is 10 mJ,
and/or
the frequency is 10 kHz.

The pulse pauses of the nanosecond laser are 100 μs.

The following parameters are advantageous for the millisecond laser:

the pulse duration is 0.5 ms-1.5 ms,
and/or
the power is 8 kW-30 kW,
and/or
the energy is 4 J-50 J,
and/or
the frequency is between 4 kHz-25 kHz.

Particularly advantageously for the millisecond laser:

the pulse duration is 0.6 ms,
and/or
the power is 15 kW,
and/or
the energy is 9 J,
and/or
the frequency is 10 Hz.

The pulse pauses of the millisecond laser are 0.1 s.

In a similar way to FIG. 2 or 5, FIG. 6 shows a through-hole 13′ in which the cylindrical inner part 10′ extends at an angle 33 to the outer surface 8′ or inner surface 8″ of the layer system 1′.

According to embodiments of the invention, the desired final geometry according to FIG. 6 is also to be achieved in this case.

First, a part 20′ in the outer layer 7, at least in the ceramic layer, which extends at an angle 33 to the surface 8′, is achieved.

In the second step, in a similar way as described in FIG. 4, the cylindrical inner part 10′ is achieved (FIG. 8).
In the last step, the diffuser 16 is produced.

FIG. 9 lists a further layer system 1″(component), in which the ceramic layer 7 is represented in more detail with a metallic layer 21 on the substrate 4 and a ceramic layer (TBC) 23 as the outermost layer on the metallic bonding layer 21.

In FIG. 9, at least in the ceramic part 23 of the coating 7, the inner diameter 29 of the part 20″ is in particular at least 10%, more particularly at least 20%, larger than the inner diameter 26 of the inner part 10″ in the metallic layer 21, or of the inner part 10″.

Overflow takes place over the component 1″ in an overflow direction 30, the through-hole 13′ extending at a tilt in the overflow direction 30. The oversize 21 is formed at the start as seen in flow direction 30, and not in the widening of the diffuser 16′.

There is therefore so to speak an overhang 24 of the TBC 23 over the metallic bonding layer 21. The inner part 10″ then extends through the metallic layer 21 and the substrate 4. Starting from FIG. 9, the diffuser part is then likewise ablated further, as represented in FIG. 6.

FIG. 10 shows a perspective view of a rotor blade 120 or guide vane 130 of a turbomachine, which extends along a longitudinal axis 121.

The turbomachine may be a gas turbine of an aircraft or of a power plant for electricity generation, a steam turbine or a compressor.

The blade 120, 130 comprises, successively along the longitudinal axis 121, a fastening region 400, a blade platform 403 adjacent thereto as well as a blade surface 406 and a blade tip 415.

As a guide vane 130, the vane 130 may have a further platform (not shown) at its vane tip 415.

A blade root 183 which is used to fasten the rotor blades 120, 130 on a shaft or a disk (not shown) is formed in the fastening region 400.

The blade root 183 is configured, for example, as a hammerhead. Other configurations as a fir-tree or dovetail root are possible.

The blade 120, 130 comprises a leading edge 409 and a trailing edge 412 for a medium which flows past the blade surface 406.

In conventional blades 120, 130, for example solid metallic materials, in particular superalloys, are used in all regions 400, 403, 406 of the blade 120, 130. Such superalloys are known for example from EP 1 204 776 B1, EP 1 306 454, EP 1 319 729 A1, WO 99/67435 or WO 00/44949.

The blades 120, 130 may in this case be manufactured by a casting method, also by means of directional solidification, by a forging method, by a machining method or combinations thereof.
Workpieces with a monocrystalline structure or structures are used as components for machines which during operation are exposed to heavy mechanical, thermal and/or chemical loads. The manufacture of such monocrystalline workpieces is carried out, for example, by directional solidification from the melt. These are casting methods in which the liquid metal alloy is solidified to form a monocrystalline structure, i.e. to form the monocrystalline workpiece, or is directionally solidified.

Dendritic crystals are in this case aligned along the heat flux and form either a rod crystalline grain structure (columnar, i.e. grains which extend over the entire length of the workpiece and in this case, according to general terminology usage, are referred to as directionally solidified) or a monocrystalline structure, i.e. the entire workpiece consists of a single crystal. It is necessary to avoid the transition to globulitic (polycrystalline) solidification in these methods, since nondirectional growth will necessarily form transverse and longitudinal grain boundaries which negate the beneficial properties of the directionally solidified or monocrystalline component.

When directionally solidified structures are referred to in general, this is intended to mean both single crystals which have no grain boundaries or at most small-angle grain boundaries, and also rod crystal structures which, although they do have grain boundaries extending in the longitudinal direction, do not have any transverse grain boundaries. These latter crystalline structures are also referred to as directionally solidified structures. Such methods are known from U.S. Pat. No. 6,024,792 and EP 0 892 090 A1.

The blades 120, 130 may likewise have coatings against corrosion or oxidation, for example (MCrAlX; M is at least one element from the group iron (Fe), cobalt (Co), nickel (Ni), X is an active element and stands for yttrium (Y) and/or silicon and/or at least one rare earth element, or hafnium (Hf)). Such alloys are known from EP 0 486 489 B1, EP 0 786 017 B1, EP 0 412 397 B1 or EP 1 306 454 A1.

The density is 95% of the theoretical density.
A protective aluminum oxide layer (TGO=thermal grown oxide layer) is formed on the MCrAlX layer (as an interlayer or as the outermost layer).

The layer composition comprises Co-30Ni-28Cr-8Al-0.6Y-0.7Si or Co-28Ni-24Cr-10Al-0.6Y. Besides these cobalt-based protective coatings, it is also exemplary to use nickel-based protective layers such as Ni-10Cr-12Al-0.6Y-3Re or Ni-12Co-21Cr-11Al-0.4Y-2Re or Ni-25Co-17Cr-10Al-0.4Y-1.5Re.

On the MCrAlX, there may furthermore be a thermal barrier coating, which is the outermost layer and consists for example of ZrO₂, Y₂O₃—ZrO₂, i.e. it is not stabilized or is partially or fully stabilized by yttrium oxide and/or calcium oxide and/or magnesium oxide. The thermal barrier coating covers the entire MCrAlX layer.

Rod-shaped grains are produced in the thermal barrier coating by suitable coating methods, for example electron beam deposition (EB-PVD).

Other coating methods may be envisioned, for example atmospheric plasma spraying (APS), LPPS, VPS or CVD. The thermal barrier coating may comprise porous, micro- or macro-cracked grains for better thermal shock resistance. The thermal barrier coating is thus more porous than the MCrAlX layer.

Refurbishment means that components 120, 130 may need to have protective layers taken off (for example by sandblasting) after their use. The corrosion and/or oxidation layers or products are then removed. Optionally, cracks in the component 120, 130 are also repaired. The components 120, 130 are then recoated and the components 120, 130 are used again.

The blade 120, 130 may be configured to be hollow or solid.

If the blade 120, 130 is intended to be cooled, it is hollow and optionally also comprises film cooling holes 418 (indicated by dashes).

Although the present invention has been disclosed in the form of preferred embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements.

1. A method for producing a through-hole in a ceramic layer system,
which comprises at least:
a substrate (4),
and
at least one outer ceramic layer,
the through-hole having an inner part
which is symmetrical,
in a cross section,
and a diffusor,
which represents a widening of the inner part on the outer surface of the ceramic layer,
wherein a part of a final geometry of the diffusor is produced first at least in the outermost ceramic layer as far as the substrate by a nanosecond laser by nanosecond pulses,
wherein a millisecond laser is then used,
to fully produce the inner part in the final geometry of the through-hole by millisecond pulses in the substrate, and
in a final working step, the diffusor is produced in its final geometry at least in the ceramic layer by the nanosecond laser by nanosecond pulses.

2. The method as claimed in claim 1,
wherein, for the nanosecond laser, at least one of
a pulse duration is 50 ns-100 ns,
a power is 50 kW-150 kW,
an energy is 8 mJ-27 mJ,
and
a frequency is between 10 kHz-40 kHz.

3. The method as claimed in claim 2, wherein at least one of a pulse duration is 100 ns,
a power is 100 kW
an energy is 10 mJ,
and
a frequency is 10 kHz.

4. The method as claimed in claim 2, wherein the pulse pauses are 100 μs.

5. The method as claimed in claim 1,
wherein, for the millisecond laser a least one of,
a pulse duration is 0.5 ms-1.5 ms,
a power is 8 kW-30 kW,
an energy is 4 J-50 J,
and
a frequency is between 4 kHz-25 kHz.

6. The method as claimed in claim 1,
wherein, for the millisecond laser at least one of,
a pulse duration is 0.6 ms,
a power is 15 kW,
an energy is 9 J,
and
a frequency is 10 Hz.

7. The method as claimed in claim 5, wherein the pulse pauses are 0.1 s.

8. The method as claimed in claim 1,
wherein the part of the diffusor is produced with an oversize in cross section relative to the inner part of the through-hole.

9. The method as claimed in claim 1,
wherein a through-hole produced in a ceramic layer system of a turbine component.

10. A component, produced by a method as claimed in claim 1.

11. A component,
which at least:
a substrate
a metallic bonding layer,
at least one outer ceramic layer,
a through-hole having
an inner part of the through-hole,
the inner part of the through-hole being symmetrical in cross section, and
a diffuser at least in the ceramic layer,
which represents a widening of the inner part, and
wherein the diffuser has an oversize in cross section relative to the inner part.

12. The component as claimed in claim 11, which comprises an overhang in the ceramic layer over the metallic layer upstream.

13. The method of claim 1, wherein the substrate is metallic.

14. The method of claim 1, wherein the at least one outer ceramic layer, is an outermost ceramic layer.

15. The method of claim 1, wherein the through-hole is cylindrical in a cross section.

16. The component of claim 11, wherein the substrate is metallic.

17. The component of claim 11, wherein the at least one outer ceramic layer, is an outermost ceramic layer.

18. The component of claim 11, wherein the through-hole is cylindrical in a cross section.
